(19) United States
(12) Patent Application Publication
(10) Pub. No.: US 2014/0293011 A1
(43) Pub. Date: Oct. 2, 2014

(54) Scanner System for Determining the Three Dimensional Shape of an Object and Method for Using

(71) Applicant: Phasica, LLC, North Sioux City, SD (US)

(72) Inventors: William Lohry, Ames, IA (US); Sam Robinson, Santa Monica, CA (US)

(73) Assignee: Phasica, LLC, North Sioux City, SD (US)

(21) Appl. No.: 14/228,397

(22) Filed: Mar. 28, 2014

Related U.S. Application Data
(60) Provisional application No. 61/806,175, filed on Mar. 28, 2013.

(51) Int. Cl. G06K 9/46; H04N 13/02

(52) U.S. Cl. CPC G06K 9/4604; H04N 13/0207; H04N 13/0239
USPC 348/47; 348/46

(57) ABSTRACT

A structured light 3D scanner comprising multiple pattern projectors each projecting a unique pattern onto an object by passing radiation through a stationary imaging substrate and one or more cameras for capturing the projected patterns in sequence. A processor processes the projected patterns based on a predetermined separation between the cameras. The processor uses this information to determine the deviation between the projected patterns and the reflected patterns captured by the camera or cameras. The deviation may be used to determine the three dimensional surface geometry of the object within the capture volume of the cameras. Surface geometry may be used to create a point cloud with each point representing a location on the surface of the object with respect to the 3D scanner.

This application is based upon U.S. Provisional Application Ser. No. 61/806,175 filed Mar. 28, 2013, the complete disclosure of which is hereby expressly incorporated by this reference.

### BACKGROUND

Engineers and digital artists often use three-dimensional (3D) scanners to create digital models of real-world objects. An object placed in front of the device can be scanned to make a 3D point cloud representing the surface geometry of the scanned object. The point cloud may be converted into a mesh importable into computers for reverse engineering, integration of hand-tuned components, or computer graphics.

Various methods of illumination, capture, and 3D mesh generation have been proposed. The most common illumination methods are structured light and laser line scanning. Most systems employ one or more cameras or image sensors to capture reflected light from the illumination system. Images captured by theses cameras are then processed to determine the surface geometry of the object being scanned. Structured light scanners have a number of advantages over laser line or laser speckle patterns, primarily a greatly increased capture rate. The increased capture rate is due to the ability to capture a full surface of an object without rotating the object or sweeping the laser. Certain techniques in structured light scanning enable the projection of a continuous illumination function (as opposed to the discrete swept line of a laser scanner) that covers the entire region to be captured; the camera or cameras capture the same region illuminated by the pattern. Traditionally, structured light scanners consist of one projector and at least one image sensor (camera). The projector and camera are typically fixed a known distance apart and disposed in such a fashion that the field of view of the camera coincides with the image generated by the projector. The overlap region of the camera and projector fields of view may be considered the capture volume of the 3D scanner system. An object placed within the capture volume of the scanner is illuminated with one or more patterns generated by the projector. Each of these patterns is often phase-shifted (i.e. a periodic pattern is projected repeatedly with a discrete spatial shift). Sequential images may have patterns of different width and periodicity. From the perspective of the camera, the straight lines of the projected image appear to be curved or wavy. Image processing of the camera's image in conjunction with the known separation of the camera and projector may be used to convert the distortion of the projected lines into a depth map of the surface of the object within the field of view of the system.

Among structured light scanners, pattern generation methods wherein a repeating pattern is projected across the full field of view of the scanner are the most common. An illumination source projects some periodic function such as a square binary, sinusoidal, or triangular wave. Some methods alter the position of an imaging substrate (e.g. a movable grating system) (See U.S. Pat. Nos. 5,581,352 and 7,400,413) or interferometers (See U.S. Pat. No. 8,248,617) to generate the patterns. The movement of the imaging substrate in these prior art methods requires very precise movement and the patterns generated will often have higher order harmonics which introduces spatial error. These disadvantages limit the applicability of movable grating systems for mass appeal.

Digital projection methods are an alternative to these hardware approaches, and allow better control over the patterns that are projected. However, while digital projectors are useful in a lab, they too suffer from several disadvantages, including: (1) variable spatial light modulators (SLM) such as Digital Light Projection (DLP) or Liquid Crystal Display (LCD) projectors are often heavy and bulky; (2) complicated electronics limit low cost production on a large scale; and (3) speed of projection is limited by either the movement of mirrors (as in a DLP) or the changing of polarization states (as in an LCD), thereby fundamentally limiting the speed of a 3D scanner producing patters with this method.

The methods disclosed herein seek to solve the problems posed by both movable imaging substrates and variable SLM projections methods by creating a solid state 3D scanner having a stationary imaging substrate, and which calculates 3D geometry in a way which requires little or no calibration of the projectors and is tolerant to imperfect projection patterns. The present invention reduces cost, increases manufacturability and increases projection speed and thereby 3D capture speed over current systems.

### SUMMARY

Various embodiments of the present invention include systems and methods for structured light 3D imaging using a scanner having multiple projectors in conjunction with one or more cameras. In some embodiments the projectors generate a sequence of patterns by projecting light through a stationary imaging substrate to illuminate a target object and the reflected light is captured by the cameras. Any suitable imaging substrate may be used to generate the sequence of patterns, including a transmissive pattern, a diffraction grating, or a holographic optical element. In particular, according to some embodiments, each projector produces a single pattern of fixed structure with variable or fixed intensity. In some embodiments, the projectors each consist of a light source, condensing optics, a transmissive pattern, and projection optics. In some embodiments, the projector consists of a light source and a diffraction grating or a holographic optical element, eliminating the need for condensing or projection optics. In some embodiments, multiple light sources may be used in conjunction with a single imaging substrate. In some embodiments, the cameras and projectors are disposed such that a portion of the cameras' field of view coincides with the spatial region illuminated by all of the projectors, the overlapping region constituting the capture volume of the scanner. In some embodiments, the projectors are activated sequentially. As each projector is illuminated one or both of the cameras capture images in such a fashion that a sequence of images is captured which allows for the generation of a set of three dimensional points representing the surface of any objects within the capture volume of the scanner system.

The use of multiple projectors to generate a sequence of fixed patterns using any suitable imaging substrate (transmissive pattern, diffraction grating, or holographic optical element) eliminates the need for a variable spatial light modulator (e.g. digital micro-mirror device or liquid crystal on silicone device) or the translation (movement) of a pattern or grating, reducing the complexity and cost inherent in current structured light projection systems for 3D scanning. Further, the fixed pattern projectors may exhibit higher image contrast than is possible with a projector relying on a variable SLM. Still further, the use of two separate images captured by two cameras eliminates the need to calibrate the projectors because both cameras are viewing the same part of the same pattern the same time.

In some embodiments, the speed of projecting and capturing the patterns is limited only by the time to turn on or off an illumination source such as an LED or laser diode, which is often measured in nanoseconds and therefore orders of magnitude faster than a changeable SLM. Further, solid-state projection patterns can be produced using common print shop tools to a high precision equivalent to a 25,000 dpi to 100,000 dpi printer, eliminating higher-order harmonics present in diffraction gratings or the need for expensive optics. In some embodiments, a monolithic set of patterns on an imaging substrate, each illuminated by a different light source, eliminates the need for complex control of a moving diffraction grating or highly precise manufacturing techniques to align multiple separate patterns, thereby reducing manufacturing cost.

In some embodiments a phase-shifting method is employed to solve many of the problems inherent in existing methods using a single pattern. In some embodiments, the system described herein uses the three-step phase shifting method, wherein three periodic projected patterns are each shifted by 2 pi/3 radians from one another. Using this method the phase measurement and triangulation can be achieved independently from the intensity of the projected patterns or object color. The most significant limitation of using this method with previous 3D scanner designs was the difficultly of achieving proper phase-shifting alignment. Variable SLMs ensure proper alignment but are expensive and slow to actuate, translatable diffraction gratings or patterns can be less expensive but introduce positioning errors which reduce system accuracy. In one embodiment of the present invention, multiple phase shifted patterns are disposed on a single monolithic imaging substrate, thereby ensuring proper alignment between each pattern. In another embodiment of the present invention each of the patterns on the monolithic imaging substrate are illuminated by a different source, thereby allowing the projection of a single pattern at a time while simultaneously insuring proper alignment between the projected patterns. In another embodiment, the direction of the phase shifting of the patterns is perpendicular to the direction of separation of the patterns. This orientation ensures the phase shift of the projected patterns is not dependent on the distance from the projectors to the illuminated plane, thereby increasing 3D scanner measurement precision over a system which does not incorporate this constraint.

In some embodiments a plurality of identical patterns are each rotated with respect to one another rather than phase shifted. This method allows significant tolerance in the placement of the discrete patterns such that they do not need to be on a monolithic substrate. Similar to the phase shifted patterns, the rotated patterns are projected one at a time and captured by one or more cameras and the images are processed to determine the 3D measurements of the surface onto which the patterns are projected.

In some embodiments an additional pattern is projected to establish correspondence between the camera images. This correspondence pattern may be attached to a monolithic imaging substrate along with other patterns or may be a discrete pattern disposed separately from other projected patterns. In some embodiments a correspondence pattern captured by one or more cameras may be used to enhance the performance of the scanner by enabling the calculation of correspondence between the pixels of two or more cameras. By identifying the pixels in each camera which detect the same portion of the projected correspondence pattern, the correspondence between the two cameras can be used in the processing of the projected images to precisely calculate the 3D geometry of a captured surface. Any suitable correspondence pattern may be used, including a random pattern, a deBruijn sequence, or a minimum Hamming distance pattern.

The components of the system may be any suitable size. In some embodiments the components are handheld or attached to a mobile device such as a mobile phone or tablet.

Various systems and methods are disclosed herein to solve the alignment and phase-shifting problems of the prior art or circumvent phase shifting altogether. The systems and methods disclosed herein provide a low-cost and high-quality 3D scanning system using triangulation of projected patterns to capture the surface profile of objects within the scanner field of view.

### BRIEF DESCRIPTION OF THE FIGURES

Having thus described various embodiments of the invention in general terms, references will now be made to the accompanying drawings, which are not necessarily drawn to scale, and wherein:

FIG. 1 is a perspective view illustrating a 3D structured light scanner according to various embodiments of the invention.

FIG. 2 is a cross-sectional view of the illumination module taken along lines A-A of FIG. 1.

FIG. 3 is a cross-sectional view of the projection module taken along lines A-A of FIG. 1.

FIG. 4 is a side view illustrating an embodiment wherein the imaging substrate is a stationary diffractive grating.

FIG. 5 is a rear perspective view illustrating a 3D structured light scanner projecting a pattern according to various embodiments of the invention.

FIG. 6 is a cross-sectional view of the 3D structured light scanner taken along lines A-A in FIG. 1.

FIG. 7 illustrates a circuit board containing illumination sources and a plurality of other electronic components according to various embodiments of the invention.

FIG. 8 is a front view of an imaging substrate having several transmissive patterns and a correspondence pattern combined thereto according to various embodiments of the invention.

FIG. 9 is an exploded view of the structured light 3D scanner according to various embodiments of the invention.

FIG. 10 is a functional block diagram of the components within the structured light 3D scanner according to various embodiments of the invention.

FIG. 11a shows a monolithic phase shifted transmissive pattern projected onto a surface.

FIG. 11b shows discrete rotated transmissive patterns projected onto a surface.

### DETAILED DESCRIPTION

Various embodiments of the invention are described more fully hereinafter with reference to the accompanying drawings, in which some, but not all embodiments of the invention are shown in the figures. Indeed, these inventions many be embodied in many different forms and should not be construed as limited to the embodiments set forth herein; rather these embodiments are provided so that this disclosure will satisfy applicable legal requirements.

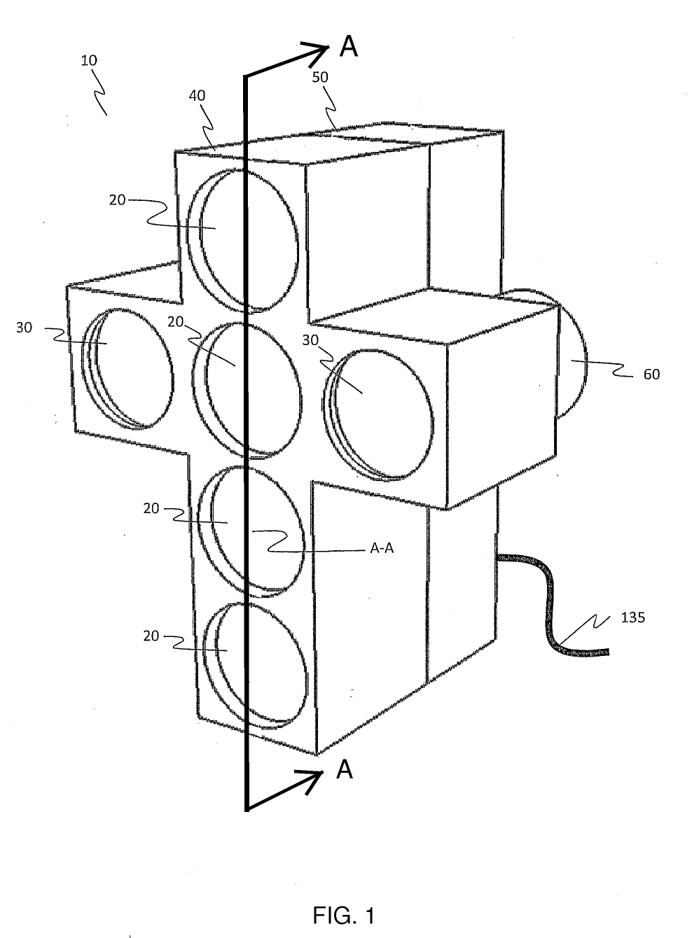

FIG. 1 illustrates one embodiment of the invention. In this embodiment, 3D scanner 10 comprises four projectors 20 each used to project a different static pattern when activated, mounting locations 30 for two cameras (one shown) 60, and a cable 135 to connect the scanner to an external computer 340 and/or a power source. In other embodiments, 3D scanner 10 may comprise any suitable number of projectors 20 and any number of cameras 60. More specifically, in this embodiment, 3D scanner 10 comprises two modules, an illumination module 50 containing the illumination sources 140 for each projector 20, and a projection module 40 containing the imaging substrate 120. In one embodiment the camera(s) 60 are part of the projection module 40. The illumination sources 140 may emit any suitable type of radiation at any wavelength. Light (or other types of radiation) from the illumination sources 140 is passed through the imaging substrate 120 to project patterns onto the object being scanned. The imaging substrate 120 may be a transmissive projection pattern 70, a diffractive element 85, or a holographic optical element. In the embodiments where the imaging substrate 120 is a transmissive projection pattern 70, the transmissive projection pattern 70 may be adapted to project patterns 80, 90, 100, 400, 510, 520, 530 through projection lenses 210, 200 which help project the illuminated pattern on to the object being scanned (not shown). As described below, the transmissive projection pattern 70 is typically comprised of several individual patterns such as patterns 80a, 90a, 100a, 110a which correspond to the projected patterns 80, 90, 100, 110 shown in FIG. 12.

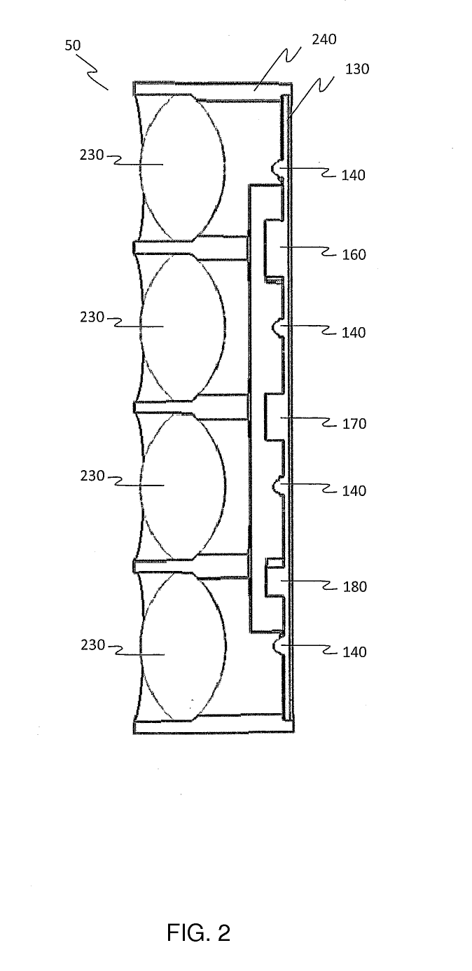

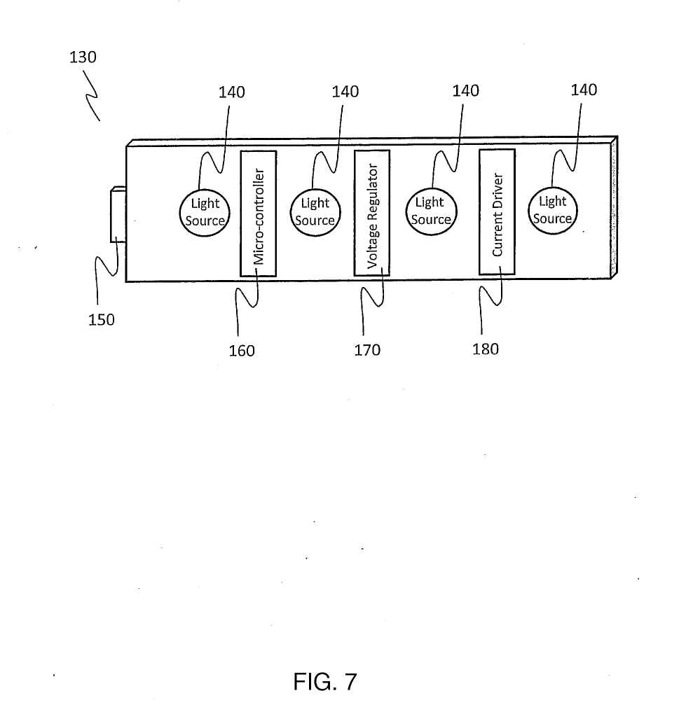

FIG. 2 illustrates a cross sectional view of an illumination module 50. In some embodiments, illumination module 50 comprises housing 240 adapted to receive four condensing lenses 230 disposed in line with four illumination sources 140. In some embodiments, illumination sources 140 are mounted on printed circuit board (PCB) 130 as further described with reference to FIG. 7. In some embodiments, condensing lens 230 collimates the light emitted by illumination source 140. In further embodiments the condensing lenses 230 collect a large portion of the light from illumination source 140 and focus it into a narrower beam in such a manner that a large portion the light falls on the imaging substrate 120. In one embodiment illumination source 140 is a white light emitting diode (LED). In some embodiments, illumination source 140 may produce any color of light, or incoherent radiation of any wavelength. In some embodiments, illumination source 140 may be a coherent light source such as, but not limited to, a laser diode of any wavelength. In some embodiments, illumination source 140 emits viable light. In some embodiments, illumination source 140 may emit light outside of the human visible range such as infrared or ultraviolet.

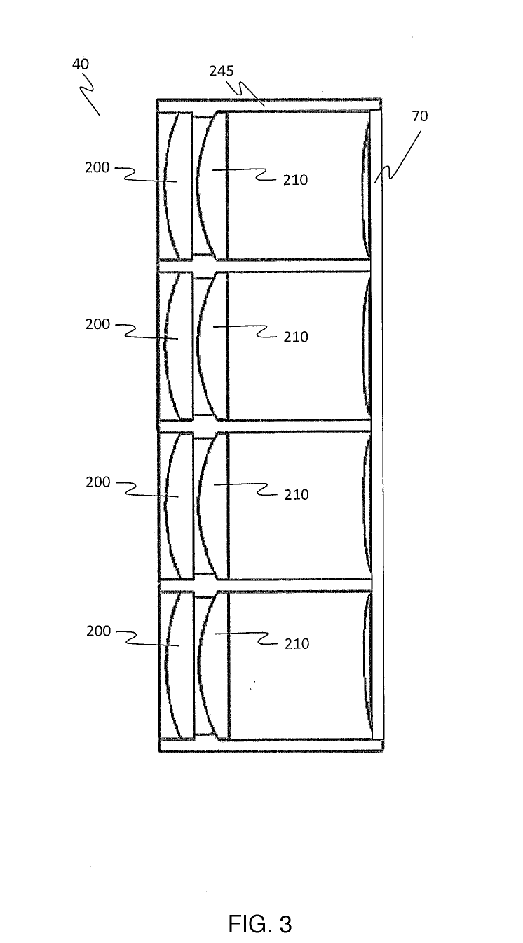

FIG. 3 is a cross-sectional view of a projection module 40 wherein the imaging substrate 120 comprises a transmissive pattern 70. In some embodiments, projection module 40 comprises a housing 245, transmissive pattern 70, and four sets of lenses, each set including first lens 210 and second lens 200. In some embodiments, light passes through transmissive pattern 70 and then through lenses 210 and 200. In some embodiments lenses 210 and 200 are positioned in such a fashion that they reimage transmissive pattern 70 onto a real image plane (not shown) on the other side of lenses 210 and 200 from transmissive pattern 70, and in this fashion project transmissive pattern 70 onto the object being scanned. In some embodiments, the orientation of lenses 210 and 200 may have any relationship with one another as well as with transmissive pattern 70; the orientation of lenses 210 and 200 in the present embodiment represent one potential orientation with respect to one another and to transmissive pattern 70 and should not be construed as the only possible orientation. In some embodiments, transmissive pattern 70 may be combined with a monolithic component such as substrate 120 comprising one or more distinct patterns 80a, 90a, 100a, 110a thereby ensuring proper alignment between the patterns. In some embodiments, transmissive pattern 70 may comprise several patterns each separate from one another and disposed in a specific relationship with one another. In some embodiments, two or more different patterns 80a, 90a, 100a, 110a comprising transmissive pattern 70 may each be disposed such that light or radiation emitted from each illumination source 140 passes through only one of the patterns 80a, 90a, 100a, 110a. In some embodiments, light or radiation from multiple illumination sources 140 may pass through a single pattern 80a, 90a, 100a, 110a that is a component of transmissive pattern 70, thereby allowing the activation of different illumination sources to cause the projection of slightly different patterns. In some embodiments, lenses 210 and 200 are disposed with respect to transmissive pattern 70 in such a fashion that the projected real image (not shown) maintains an acceptable degree of focus within a desired range of distances from projection module 40, ensuring the projected pattern 80, 90, 110, 110, 400, 510, 520, 530 has the desired level of focus or defocus when it illuminates the object being scanned. In some embodiments, inclusion of condensing lens 230 increases the brightness of projector 20 by ensuring more light or radiation from illumination source 140 passes through transmissive pattern 70 and projection optics 210 and 200 than in a system without a condensing lens. In some embodiments, projection lenses 210 and 200 enable more control of the level of focus of projected pattern 80, 90, 110, 110, 400, 510, 520, 530 within the functional region of 3D scanner 10 than a system without projection optics; increased control of the focus or defocus level of projected pattern 80, 90, 110, 110, 400, 510, 520, 530 enables a system with lower error and higher precision and accuracy.

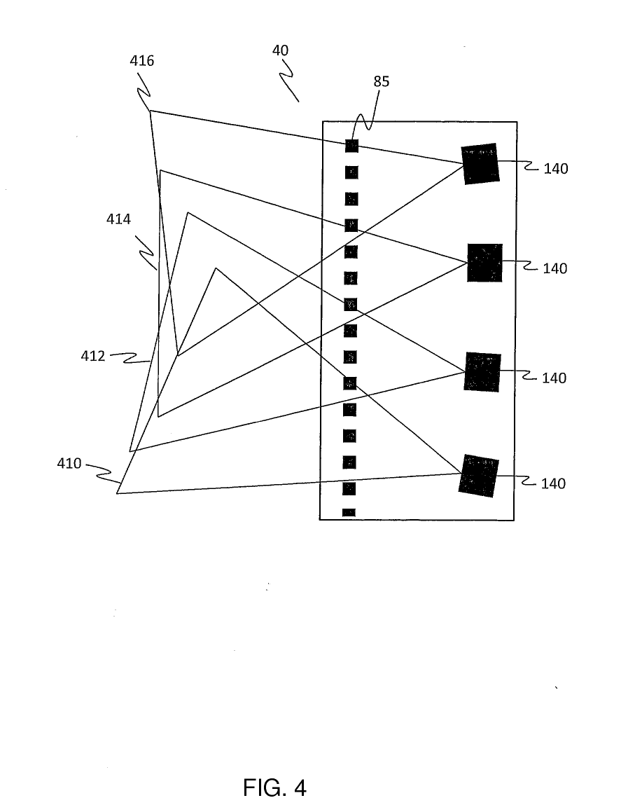

FIG. 4 illustrates a diagram of projection module 40 according to various embodiments of the invention wherein the imaging substrate 120 comprises a diffractive element 85 which eliminates the need for lenses 210 and 200. In some embodiments, projection module 40 may contain a single diffractive element 85 and one or more coherent illumination sources 140, in such a fashion that the activation of each illumination source 140 causes the projection of a different pattern as the light (or other radiation) passes through the stationary diffractive element 85. In some embodiments, diffractive element 85 may comprise several patterns each separate from one another and disposed in a specific relationship with one another. The patterns in this embodiment are small openings or slits in the generally opaque diffractive element 85 which cause light transmitted therethrough to project a pattern 410, 412, 414, 416 on the object. In some embodiments, different patterns comprising diffractive element 85 may each be disposed such that light or radiation emitted from each illumination source 140 passes through separate patterns to create distinct projected patterns 410, 412, 414, 416. In some embodiments, light or radiation from multiple illumination sources 140 may pass through a single pattern (not shown) that is a component of diffractive element 85. In some embodiments radiation or light emitted from illumination source 140 may pass through diffractive element 85 and generate patterns 410, 412, 414, 416 at some position in front of 3D scanner 10 (not shown) and on the opposite side of diffractive element as illumination source 140. In some embodiments, multiple patterns 410, 412, 414, 416 generated by radiation or light emitted by illumination source 140 passing through diffractive element 85 may all have the same structure but be shifted spatially with respect to one another; the degree of spatial shifting of the patterns 410, 412, 414, 416 with respect to one another may be related to the spacing and relative orientation of illumination sources 140 with respect to one another. In some embodiments, diffractive element 85 may be transmissive. In some embodiments diffractive element 85 may be reflective such that patterns 410, 412, 414, 416 may be generated on the same side of diffractive element 85 as illumination source 140.

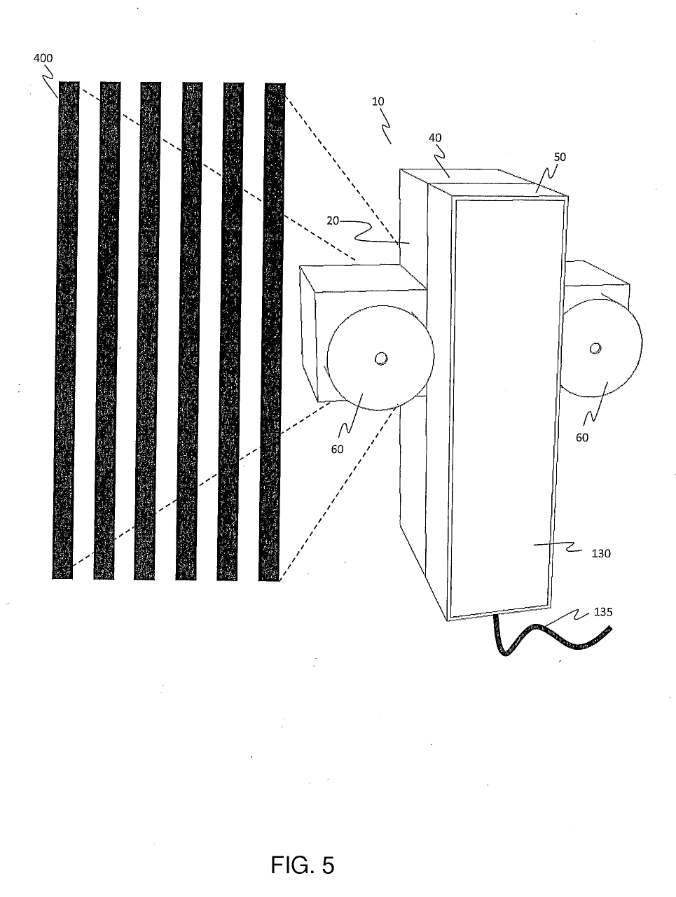

FIG. 5 illustrates one embodiment of the present invention. In some embodiments, exemplary pattern 400 is generated by projector 20 of 3D scanner 10. In some embodiments, 3D scanner 10 comprises at least two projectors 20 each projecting a single distinct pattern (See, e.g. the projected patterns shown in FIGS. 4,11a, and 11b). In some embodiments, projected patterns 80, 90, 110, 110, 400, 410, 412, 414, 416 510, 520, 530 may be a plurality of monochromatic lines of uniform intensity; two-dimensional monochromatic binary patterns; or a plurality of monochromatic patterns with a sinusoidal intensity pattern in two dimensions. In some embodiments, projected patterns 80, 90, 110, 110, 400, 410, 412, 414, 416 510, 520, 530 may be a plurality of colored lines of uniform intensity; two dimensional colored binary patterns; or a plurality of colored patterns with a sinusoidal intensity pattern in two dimensions. In some embodiments, projector 20 produces a monochrome pattern of random intensity levels in one axis, or a monochrome pattern of random intensity levels in two axes. In some embodiments, projector 20 produces a color pattern of random intensity levels in one axis, or a color pattern of random intensity levels in two axes. In some embodiments, cameras 60 are disposed such that their fields of view substantially overlap with the pattern 400 as well as the patterns from the other projectors 20.

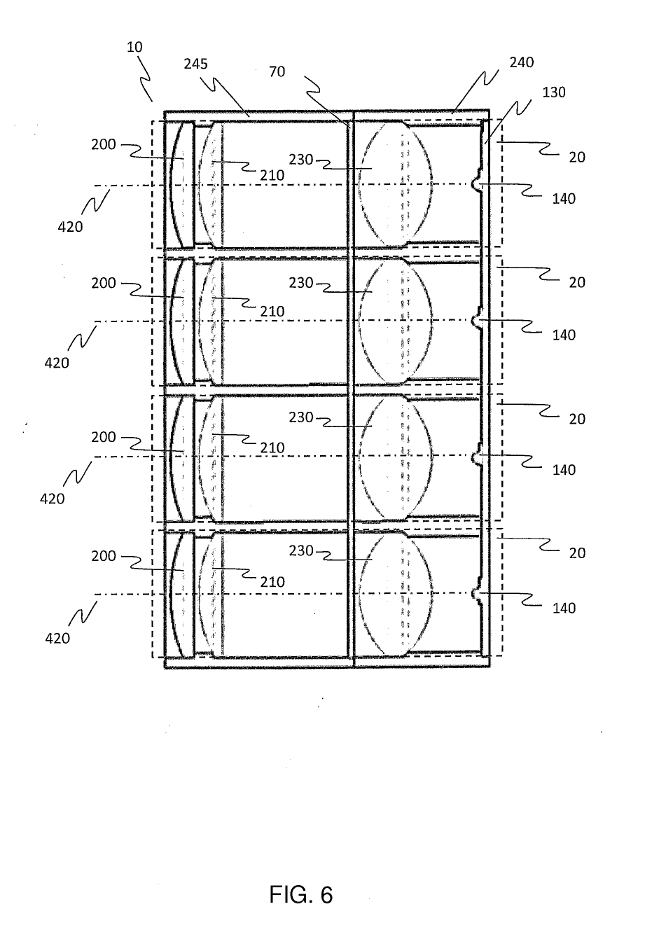

FIG. 6 illustrates a cross-sectional view of one embodiment of the present invention. In one embodiment of the present embodiment, 3D scanner 10 is comprised of four projectors 20, wherein the front half of each projector 20 is defined by projection module housing 245, and the back half of each projector is defined by illumination module housing 240. In one embodiment, printed circuit board 130 contains four illumination sources 140 and is attached to the rear of illumination module housing 240. In some embodiments there may be any number of illumination sources 140. In some embodiments, condensing lens 230, first projection lens 210 and second projection lens 200 may be disposed in front of the illumination source 140 and centered on, and normal to optical axis 420. In some embodiments, condensing lens 230, first projection lens 210 and second projection lens 200 may be disposed in a position other than centered on, or normal to optical axis 420. In some embodiments, condensing lens 230 may be disposed so as to collimate the radiation or light emitted by illumination source 140. In some embodiments, condensing lens 230 may be disposed in a fashion that does not collimate the radiation or light emitted by illumination source 140. In some embodiments, transmissive pattern 70 may be disposed in such a fashion that the light or radiation emitted from illumination source 140, and passing through condensing lens 230 passes through a portion of transmissive pattern 70 containing a single pattern 80a, 90a, 110a, 110a. In some embodiments, transmissive pattern 70 may be disposed in such a fashion that the light or radiation emitted from illumination source 140, and passing through condensing lens 230 passes through a portion of transmissive pattern 70 containing more than one pattern 80a, 90a, 110a, 110a. In some embodiments, first lens 210 and second lens 200 may be disposed in such a fashion that they reimage a portion of transmissive pattern 70 into a real image plane (not shown) on the other side of lenses 210 and 200 from transmissive pattern 70. In some embodiments, lenses 210 and 200 may be disposed is such a fashion that they are centered on and normal to optical axis 420. In some embodiments, lenses 210 and 200 may be disposed is such a fashion that they are not centered on or normal to optical axis 420. In some embodiments, transmissive pattern 70 may be replaced with diffractive or holographic element 80 as discussed above. In some embodiments, condensing lens 230 may not be present. In some embodiments first lens 210 may not be present, in other embodiments second lens 200 may not be present; in further embodiments neither first lens 210 nor second lens 200 may be present. In some embodiments, additional projection lenses (not shown may be present and disposed in relationship to lenses 210 and 200 so as to reimage transmissive pattern 70). In some embodiments, projection lenses 210 and 200 may reimage a plane other than the plane where transmissive pattern 70 is located. In some embodiments 3D scanner 10 may contain more fewer than four projectors 20, in further embodiments 3D scanner 10 may contain more than four projectors 20.

FIG. 7 illustrates printed circuit board 130 containing illumination sources 140, microcontroller 160, voltage regulator 170, current driver 180 and external connection port 150. In some embodiments four illumination sources 140 may be attached to printed circuit board 130. In some embodiments printed circuit board 130 may contain more than four illumination sources 140. In further embodiments, printed circuit board 130 may contain fewer than four illumination sources 140. In some embodiments, multiple printed circuit boards 190 (only one shown) may each contain one or more illumination sources 140. In some embodiments, printed circuit board 130 may have a thermally conductive backing (not shown) that conducts heat from the illumination sources 140 and acts as a heat sink. In some embodiments, printed circuit board 130 may contain additional circuitry including, but not limited to, resistors, capacitors, inductors, transformers, diodes, fuses, batteries, digital signal processors, oscillators, crystals, and integrated circuit components. In some embodiments, illumination sources 140 may be disposed along the center line (not shown) of the printed circuit board 130 and separated by a uniform distance. In further embodiments, illumination sources 140 may be disposed on the printed circuit board 130 in a non-uniform fashion.

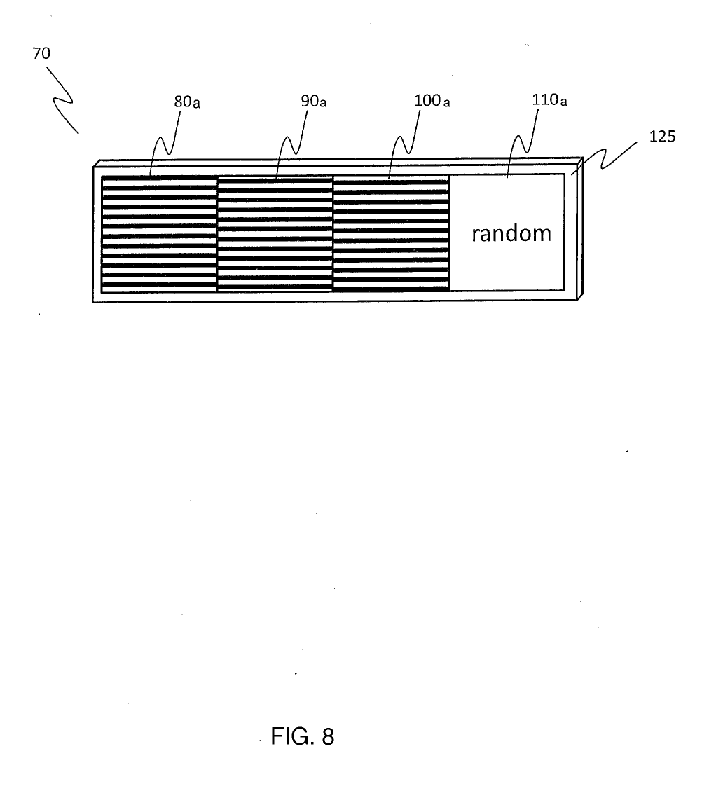

FIG. 8 illustrates a diagram of transmissive pattern 70. In some embodiments, transmissive pattern 70 may comprise a transmissive substrate 125 having four transmissive patterns 80a, 90a, 100a, 110a combined therewith. In some embodiments, transmissive patterns 80a, 90a, 100a, 110a may be made of a transmissive film affixed to the surface of transmissive substrate 125. In further embodiments, transmissive patterns 80a, 90a, 100a, 110a may comprise a coating applied directly to the surface of transmissive substrate 125. In further embodiments, transmissive patterns 80a, 90a, 100a, 110a may formed from the same material as the transmissive substrate 125 and be created by optical, chemical or other treatment to transmissive substrate 125. In some embodiments, transmissive substrate 125 may contain more than four transmissive patterns. In further embodiments, transmissive substrate 125 may contain fewer than four transmissive patterns. In some embodiments, transmissive substrate 125 may comprise a monolithic material. In other embodiments transmissive substrate 125 may comprise multiple transmissive substrate sections (not shown). In some embodiments, transmissive patterns 80a, 90a, 100a, 110a may all be portions of a monolithic substrate. In other embodiments, transmissive patterns 80a, 90a, 100a, 110a may each be separate patters individually affixed to transmissive substrate 125 or transmissive substrate segments (not shown). In some embodiments, alignment of transmissive patterns 80a, 90a, 100a, 110a with respect to one another may be critical; alignment may be achieved by fabricating all portions of transmissive patterns 80a, 90a, 100a, 110a on a single monolithic transmissive film; alternatively, alignment may be achieved by placing separate segments of transmissive film, each containing one or more transmissive patterns 80a, 90a, 100a, 110a onto transmissive substrate 125 with proper orientation during manufacturing. In some embodiments, transmissive patterns 80a, 90a, 100a may depict a sinusoidal or triangular wave of transmissivity. In further embodiments, patterns 80a, 90a, 100a may be phase-shifted. In further embodiments, transmissive patterns 80a, 90a, 100a may be phase-shifted by a value of 2*pi/3 radians. In further embodiments, transmissive patterns 80a, 90a, 100a may be phase-shifted by pi/2 radians. In further embodiments, transmissive patterns 80a, 90a, 100a may be phase-shifted by pi/4 radians. In further embodiments, transmissive patterns 80a, 90a, 100a may be phase-shifted by any other radian value. In some embodiments, transmissive patterns 80a, 90a, 100a may each be phase-shifted by different radian values. In further embodiments, more than four transmissive patterns may be phase-shifted by any radian value; fewer than four transmissive patterns may be phase-shifted by any radian value.

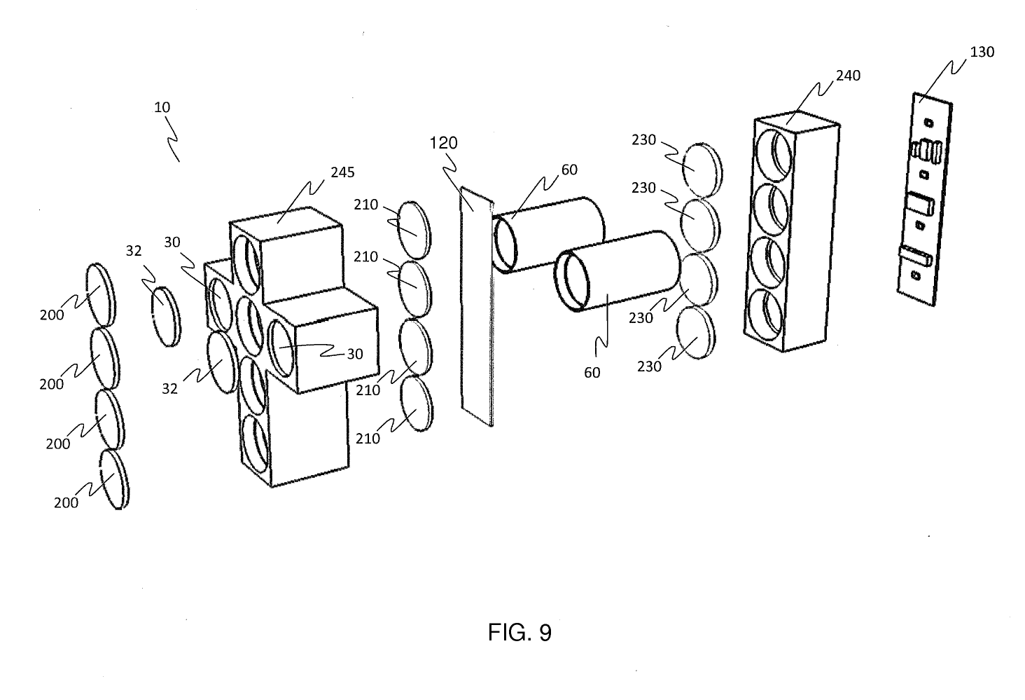

FIG. 9 illustrates an embodiment of an exploded diagram of 3D scanner 10. In some embodiments, 3D scanner 10 comprises a printed circuit board 130 with illumination sources 140, illumination module 50 containing condensing lenses 230, projection module 40 including an imaging substrate 120, first projection lenses 210, second projection lenses 200, camera mounts 30 and camera lenses 32, and cameras 60. In the embodiment shown in FIG. 9, the imaging substrate 120 is preferably a transmissive pattern 70 due to the inclusion of lenses 200, 210. In some embodiments, printed circuit board 130 and condensing lenses 230 may be mounted into illumination module housing 240, first lenses 210 and second lenses 200 as well as imaging substrate 120 may be inserted and mounted into projection module housing 245, camera lenses 32 may be inserted and mounted into camera mounts 30, and cameras 60 may also be inserted and mounted into camera mounts 30 in the projection module housing 245. In this fashion, components of 3D scanner 10 may be assembled into two modules, illumination module 50 and projection module 40. In some embodiments, decoupling projection module 40 from illumination module 50, while incorporating imaging substrate 120 in projection module 40 ensures proper orientation between imaging substrate 120 with first and second projection lenses 210 and 200 without requiring perfect alignment between illumination source 140, condensing lens 230 and transmissive pattern 70, thereby reducing manufacturing complexity. In other embodiments, illumination sources 140, condensing lens 230, imaging substrate 120, and first and second projection lenses 210 and 200 may all be incorporated into a single housing without separate illumination module 50 or projection module 40. In further embodiments, camera 60 may be incorporated into printed circuit board 130. In some embodiments, lenses 210, 200, 32, 230 may be fixed in place with adhesive; alternatively lenses 210, 200, 32, 230 may be held in place by a retaining ring (not shown). In some embodiments, the imaging substrate 120 may be fixed to projection module housing 245 with adhesive or any other permanent or temporary means. In some embodiments, cameras 60 may be fixed to projection module housing 245 with adhesive; alternatively, cameras 60 may be held in place by a retaining ring (not shown). In further embodiments, camera 60 may be fixed to illumination module housing 240. In some embodiments, 3D scanner 10 may include a stand (not shown); alternatively 3D scanner 10 may include a removable stand. In some embodiments, 3D scanner 10 may include a stand with an attached turn table (not shown) to rotate an object being scanned (not shown). In further embodiments, turn table (not shown) may not be connected to either the stand (not shown) or the 3D scanner 10.

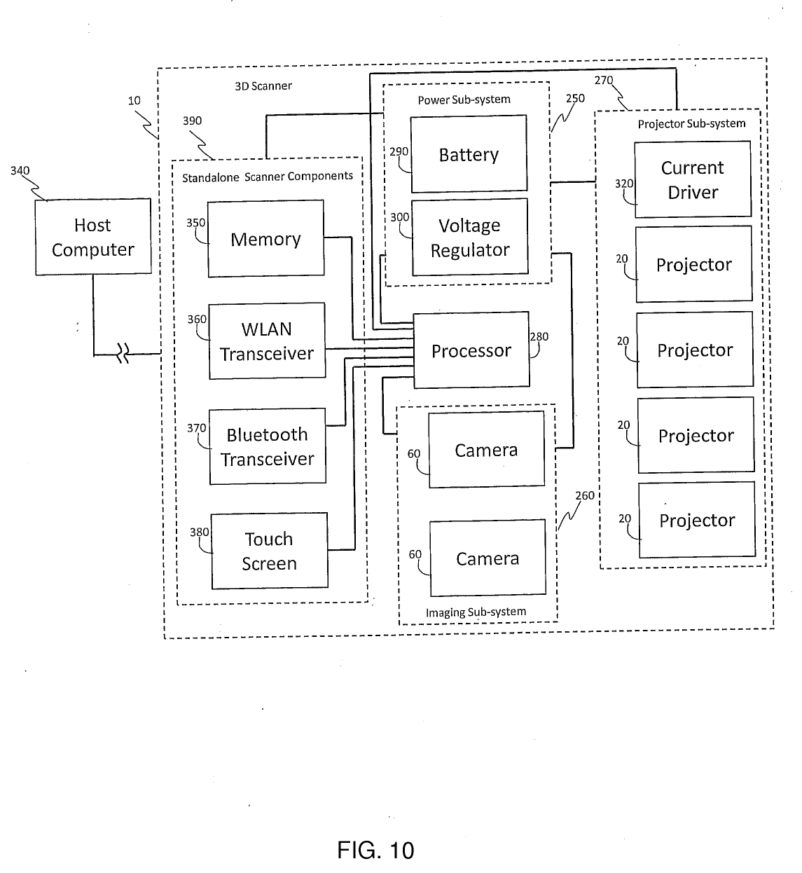

FIG. 10 illustrates a schematic depiction of a number of functional components of 3D scanner 10. In some embodiments, 3D scanner 10 may be a handheld or table mounted device comprising projector sub-system 270, imaging sub-system 260, power sub-system 250, processor 280, and may contain standalone scanner components 390. In some embodiments, 3D scanner 10 may not contain standalone scanner components 390.

In some embodiments, projector sub-system 270 may contain one or more projectors 20 and one or more current drivers 320. In some embodiments, sub-system 270 may contain four projectors 20 and one current driver 320. In some embodiments, current driver 320 may supply projectors 20 with a constant current at a constant voltage; alternatively, current driver 320 may supply projectors 20 with any current or voltage. In some embodiments, current driver 320 may supply power to one projector 20 at a time. In further embodiments, current driver 320 may supply projectors 20 with power sequentially, one projector 20 receiving power at a given moment to illuminate and project a single pattern 80, 90, 100, 110, 400, 410, 412, 414, 416, 510, 520, or 530. In an alternative embodiment, current driver 320 may supply more than one projector 320 with power at a given moment and then supply power to a different set of projectors 20 at another moment. In another embodiment, current driver 320 may supply a current of constant value to one or more projectors 20 while using pulse width modulation, varying the duty cycle of power application to projectors 20; in this fashion, the brightness of projectors 20 may be controlled by varying the duty cycle of the power provided by current driver 320. In some embodiments, two or more projectors 20 may be illuminated simultaneously each receiving power from current driver 320 at a different duty cycle, thereby independently controlling brightness of multiple projectors 20 simultaneously.

In some embodiments, current driver 320 may be controlled by processor 280; in this fashion, the state of illumination and brightness of each projector 20 may be controlled. In some embodiments, processor 280 may be connected to imaging sub-system 260; in this fashion processor 280 may trigger the capture of cameras 60 as well as the illumination state of projectors 20. In another embodiment, camera 60 capture rates may be fixed and processor 280 may trigger the illumination state of projectors 20 to coincide with the capture rate of cameras 60. In some embodiments, processor 280 may facilitate a state of camera 60 capture and illumination of projector 20 such that images generated by projectors 20 may be captured by cameras 60. In some embodiments, a first frame captured by cameras 60 may contain an image generated by first projector 20, a second frame captured by cameras 60 may contain an image generated by a second projector 20. In some embodiments, a first frame captured by cameras 60 may contain images generated by the simultaneous illumination of a set of two or more projectors 20, a second frame captured by cameras 60 may contain images generated by the simultaneous illumination of a different set of two or more projectors 20. In some embodiments, processor 280 may perform image processing on captured frames from cameras 60. In some embodiments, processor 280 may perform image processing on captured frames from cameras 60 thereby generating three dimensional point clouds; generated point clouds may represent objects imaged by 3D scanner 10. In some embodiments, processor 280 may perform compression of three dimensional point clouds or models.

In some embodiments, 3D scanner 10 may connect to host computer 340 wirelessly. In some embodiments, 3D scanner 10 may wirelessly connect to host computer 340 via Bluetooth transceiver 370. In another embodiment, 3D scanner 10 may wirelessly connect to host computer 340 via WLAN transceiver 370. In some embodiments, 3D scanner 10 may wirelessly connect to host computer 340 via Bluetooth transceiver 370 and via WLAN transceiver 370. In some embodiments, 3D scanner 10 may connect with a smart phone (not shown) via Bluetooth transceiver 370 and/or WLAN transceiver 360. In some embodiments, 3D scanner 10 may include onboard memory 350 for storage of two dimensional images or videos, and/or three dimensional point clouds or models. In some embodiments, 3D scanner 10 may be connected via one or more cables to host computer 340; host computer 340 may perform computational tasks central to the function of 3D scanner 10 including processing and rendering of three dimensional models. In other embodiments, host computer 340 may be used to display three dimensional models, images and/or videos captured and rendered by 3D scanner 10. In further embodiments, 3D scanner 10 may be connected to host computer 340 via WLAN transceiver 360 and/or Bluetooth transceiver 370. In further embodiments, 3D scanner 10 may not be attached to host computer 340. In further embodiments, all processing and rendering may be performed by 3D scanner 10; three dimensional models, images and/or may be displayed by touch screen 380 contained within 3D scanner 10. In some embodiments, touch screen 380 may react to user touch and gestural commands. In some embodiments, touch screen 380 may not respond to user touch or gestural commands. In some embodiments, 3D scanner 10 may not include touch screen 380.

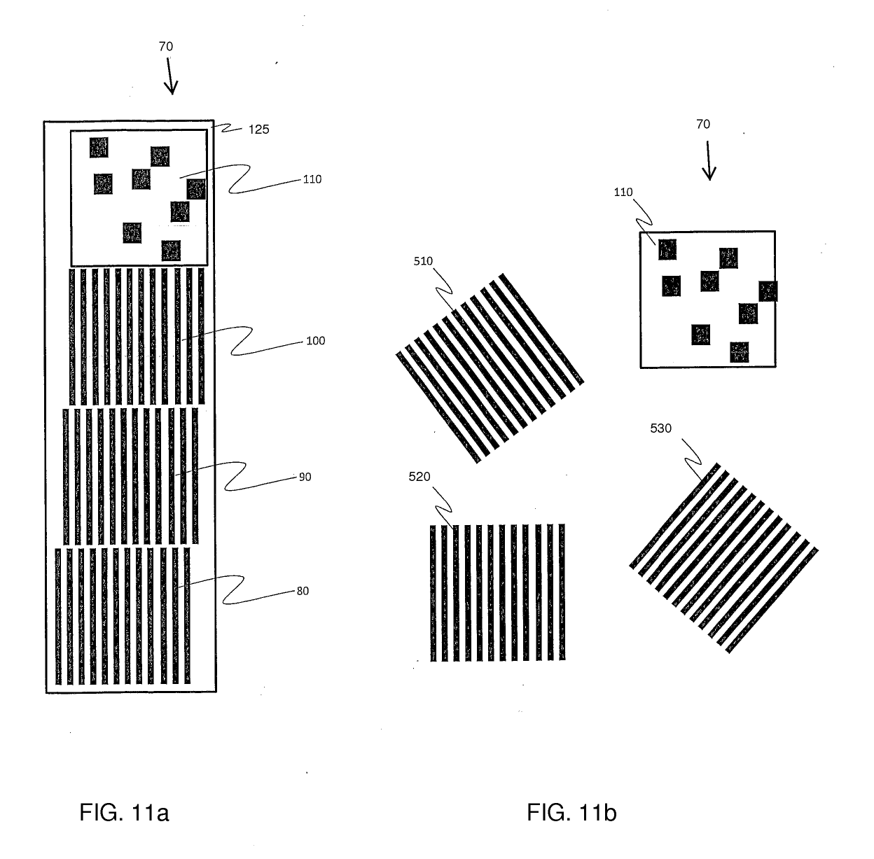

FIGS. 11a and 11b illustrate two exemplary projected patterns for 3D scanner 10, specifically in FIG. 11a shows a monolithic pattern, and FIG. 11b shows a plurality of separate patterns.

In one embodiment FIG. 11a comprises substrate 120 that is a transmissive substrate 125 containing precisely phase shifted and periodic patterns 80a, 90a, and 100a as well as correspondence pattern 110a (shown on the substrate in FIG. 8). When projected, patterns 80, 90 and 100 generate an image with periodically varying intensity on the surface being scanned, and correspondence pattern 110 generates a known image used to establish correspondence between the camera images. By disposing patterns 80a, 90a, 100a and 110a on a single monolithic transmissive substrate 125, proper alignment between patterns 80, 90 and 100 may be ensured without highly precise and costly manufacturing methods. FIG. 11a illustrates the embodiment wherein the direction of the phase shifting of the projected patterns 80, 90, and 100 is generally perpendicular to the direction of separation of the patterns. As shown, the projected patterns 80, 90, 100 are phase shifted along the x-axis while the projected patterns 80, 90, 100 are separated from each other along the y-axis. This orientation helps ensure the phase shift of the projected patterns 80, 90, 100 is not dependent on the distance from the projectors to the illuminated plane, thereby increasing 3D scanner measurement precision over a system which does not incorporate this constraint. In other embodiments, patterns 80, 90, and 100 may not be periodic. In other embodiments pattern 110 may not be random.

In one embodiment FIG. 11b comprises a plurality of separate periodic patterns 510, 520, 530 projected onto a surface as well as a separate correspondence pattern 110. In one embodiment the projected periodic patterns 510, 520, 530 may be rotated with respect to one another, in such a fashion that when they are projected a camera capturing images of the projected patterns is able to distinguish between the different patterns. In the embodiment shown, the lines in projected patterns 510, 520, 530 are rotated at about forty-five degrees relative to each other. In one embodiment projected periodic patterns 510, 520, 530 and correspondence pattern 110 may have any arbitrary spacing and relative rotation between them so long as periodic patterns 510, 520, 530 are sufficiently rotated with respect to one another so as to allow their projected patterns to be distinguished from other another. In one embodiment periodic patters 510, 520, 530 and correspondence pattern 110 may all lay on the same plane. In another embodiment, periodic patterns 510, 520, 530 and correspondence pattern 110 may lie on different planes than one another. In another embodiment patterns 510, 520, 530 may not be periodic. In some embodiments any suitable correspondence pattern 110 may be used, including a random pattern, a deBruijn sequence, or a minimum Hamming distance pattern.

Some embodiments include a method of using the correspondence pattern 110 to help generate the 3D image. As discussed above, some embodiments include the use of two separate cameras 60. Each camera 60 captures an independent image of the patterns projected onto the object. It should be noted that as few as two patterns may be used in the present invention—one correspondence pattern 110 and one non-correspondence pattern (such as 80, 90, 100, 400, 410, 412, 414, 416, 510, 520, or 530). The various patterns, including the correspondence pattern 110, are sequentially projected onto the object and captured and processed by the system. The correspondence pattern 110 includes one or more definable unique areas which may be easily identified by both cameras 60 (in contrast to the non-correspondence patterns whose periodic characteristics may make it difficult for the system to distinguish between different regions of the pattern). The one or more unique areas of the correspondence pattern 110 are identified and stored by the system in a memory so their position on the object can be identified when the other (non-correspondence 110) pattern(s) is (are) projected. The unique area of the non-correspondence 110 pattern(s) is (are) captured by both cameras 60 and compared by the processor. Triangulation is obtained by determining the optimal shift for each pixel in the unique area for each non-correspondence pattern. At first, the cross-section of the lines in the non-correspondence pattern will not line up since each camera 60 sees the pattern from a different angle. By shifting each pixel and knowing the separation distance between the cameras, the correct shift can be obtained for each non-correspondence pattern. Once this shift is computed, the processor uses this information to create the 3D image of the object through conventional means.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included within the scope of the following claims.

What is claimed is:

1. A scanner system for determining a three dimensional shape of an object, said system comprising:
a stationary imaging substrate for creating at least two distinct patterns;
at least two illumination sources, each illumination source for projecting one of the at least two distinct patterns onto the object to create a sequence of projected patterns;
a camera for capturing the sequence of projected patterns; and
at least one processor for controlling the illumination sources and camera and for processing the captured sequence of projected patterns to generate the three dimensional shape of the object.

2. The system of claim 1 wherein the imaging substrate is a transmissive pattern.

3. The system of claim 1 wherein the imaging substrate is a diffractive element.

4. The system of claim 1 wherein at least one of the at least two distinct patterns is a correspondence pattern.

5. The system of claim 1 wherein the at least two distinct patterns are combined on a single monolithic substrate.

6. The system of claim 1 wherein the at least two distinct patterns are separated from each other in a first direction.

7. The system of claim 6 wherein the at least two distinct patterns are phase shifted in a second direction that is generally perpendicular to the first direction.

8. The system of claim 1 wherein the at least two distinct patterns have an x-axis and a y-axis and the at least two distinct patterns are phase shifted along the x-axis and separated from each other along the y-axis.

9. The system of claim 1 wherein at least two cameras are used and there is a predetermined distance between the at least two cameras, said predetermined distance is known by the processor.

10. The system of claim 9 wherein the at least two cameras have overlapping fields of view.

11. A scanner system for determining a three dimensional shape of an object, said system comprising:
at least two illumination sources which when activated pass through an imaging substrate having at least two distinct imaging patterns thereon such that each illumination source projects a distinct structured light pattern onto the object;
at least two image sensors for capturing a sequence of images, the sequence of images including the structured light patterns projected by the at least two illumination sources;
wherein there is a fixed separation between the at least two image sensors;
a processor for determining a plurality of three dimensional points of interest on the object based on triangulation between each of the plurality of three dimensional points of interest and the fixed separation between the at least two image sensors; and
wherein the plurality three-dimensional points of interest form a point cloud.

12. The system from claim 11, wherein the structured light patterns comprise a plurality of monochromatic lines.

13. The system from claim 11, wherein the structured light patterns comprise a plurality of chromatically varying lines.

14. The system from claim 11, wherein the structured light patterns comprise a plurality of monochromatic phase-shifted lines.

15. The system from claim 11, wherein the structured light patterns comprise a plurality of chromatic phase-shifted lines.

16. The system from claim 11, wherein each structured light pattern is identical but rotated relative to the other structured light patterns.

17. The system from claim 11, wherein each structured light pattern is identical but rotated about 45 degrees relative to the other structured light patterns.

18. The system from claim 11, where at least one of the structured light patterns is periodic and at least one of the structured light patterns is a correspondence pattern.

19. The system from claim 11, wherein each structured light pattern comprises lines which are offset from the lines in the other structured light patterns by a fixed and known amount.

20. The system from claim 11, wherein each illumination source projects a distinct structured light pattern.

21. The system according to claim 20, wherein the imaging patterns are disposed on a single monolithic substrate.

22. The system according to claim 20, wherein each imaging pattern is disposed on a separate substrate.

23. The system from claim 11, wherein each illumination source produces a light emission and the light emission from each illumination source passes through the imaging substrate from a different angle, thereby enabling the activation of each illumination source to project a structured light pattern which is slightly offset from the structured light patterns generated by the activation of the other illumination sources.

24. The system from claim 11, wherein the imaging patterns and the illumination sources are combined on a monolithic component.

25. The system from claim 11, wherein the illumination sources produce visible light.

26. The system from claim 11, wherein the illumination sources produce infrared light.

27. The system of claim 11 wherein one of the structured light patterns is a correspondence pattern.

28. A method for determining a three dimensional shape of an object using a scanner system, said method comprising:
projecting at least two distinct projected patterns onto the object using a separate illumination source for projecting each of the at least two distinct projected patterns, wherein each of the at least two distinct projected patterns is projected sequentially to create a sequence of projected patterns;
capturing the sequence of projected patterns using a camera; and
processing the sequence of projected patterns captured by the camera to generate the three dimensional shape.

29. The method of claim 28 wherein the at least two distinct projected patterns are projected by passing radiation through a stationary imaging substrate having at least two distinct imaging patterns thereon which correspond to the at least two distinct projected patterns.

30. The method of claim 29 wherein the at least two distinct imaging patterns are combined on a single monolithic substrate.

31. The method of claim 29 wherein the at least two distinct imaging patterns are separated from each other in a first direction.

32. The method of claim 31 wherein the at least two distinct imaging patterns are phase shifted in a second direction that is generally perpendicular to the first direction.

33. The method of claim 28 wherein at least two cameras are used and there is a predetermined distance between the at least two cameras, said predetermined distance is known by the processor.

34. The method of claim 28 wherein a first camera and a second camera are used to independently capture the sequence of projected patterns, each camera having a field of view; and
wherein one of the at least two distinct projected patterns is a correspondence pattern having a unique area projected onto the object and one of the at least two distinct projected patterns is a non-correspondence pattern.

35. The method of claim 34 further comprising the step of identifying the unique area of the correspondence pattern in the first camera's field of view and identifying the unique area of the correspondence pattern in the second camera's field of view.

36. The method of claim 35 further comprising the step of storing the unique area projected onto the object in a memory so the unique area on the object can be identified when the non-correspondence pattern is projected onto the object.

37. The method of claim 36 further comprising the step of triangulating the unique area on the object when the non-correspondence pattern is projected onto the object by determining a subpixel shift between the unique area of the non-correspondence pattern captured by the first camera and the unique area of the non-correspondence pattern captured by the second camera.
